(19) United States
(12) Patent Application Publication
(10) Pub. No.: US 2013/0000164 A1
(43) Pub. Date: Jan. 3, 2013

(54) Greeting Cards

(76) Inventors: Harshad Jayantilal Shah, Kowloon Bay (HK); Man Dong Ho, Kowloon Bay (HK)

(21) Appl. No.: 13/535,911

(22) Filed: Jun. 28, 2012

(30) Foreign Application Priority Data
Jun. 30, 2011 (CN) 201110185464.0

(51) Int. Cl. G09F 1/04

(52) U.S. Cl. 40/124.02; 40/124.09; 40/124.03

(57) ABSTRACT

A greeting card is provided. The greeting card has a back cover, a front cover, a control module, a movable component, and a protective cover. The back cover is configured as the base of the greeting card. The front cover is coupled to the back cover and contains a window. The front cover can be folded over the back cover. The control module is mounted within or on the back cover. The movable component is mounted within or on the back cover and is driven by the control module The window is located on a location on the front cover corresponding to the movable component. The protective cover is mounted within the window and configured to protect the movable component and provide moving space for the movable component.

### FIELD OF INVENTION

This invention relates generally to greeting cards and, more particularly, to a greeting card or a promotional mailer that have a movable component and a protective cover.

### BACKGROUND

Greeting cards are commonly used cultural merchandise. Currently, static single-page or folded-page greeting cards and a variety of music greeting cards with an electronic circuit module are popular on the market.

Greeting cards are extensively used in social activities such as birthday, graduation, wedding, holiday and other celebratory activities, mainly to convey inter-personal emotional information. Promotional mailers are similarly manufactured as greeting cards, with the users being mainly commercial entities. Promotional mailers are usually used in promotional activities such as showing to potential clients or customers, or conveying the information about goods or services to attract potential clients or consumers.

The expressional elements of greeting cards are not limited to image, word, shape, sound, and music, but may include elements such as motion, light, and video. To make more expressive and attractive greeting cards, people have been attempting to combine as many elements that express emotion or information as possible. For example, Chinese patent literature ZL02232493.3 disclosed a greeting card with electronically-recorded music, comprising a base plate of an electronic circuit module, a cover/music box of the electronic circuit module, and the electronic circuit module. It also allows printing, writing and drawing words or image designs, recording and playing speeches of a user or other sounds, and playing music or other sounds fixed in circuit.

The patent literature WO 2010/069163 A1 disclosed a greeting card having a base page and a cover folded on the base page, and the base page contains an integrated circuit block, a pull slice switch, a loudspeaker and an LCD connected with the integrated circuit block. The integrated circuit block includes a memory module for storing digital photographs, a main control chip module which encodes the digital photographs and transmits the digital photographs to the LCD. The electric greeting card conveniently displays the digital photographs stored in the memory module on the LCD, and satisfies the needs of consumers to transmit dynamic digital photographs.

The United Kingdom patent literature “Greeting card with audio message facility (GB2278949)” disclosed a greeting card having an apparatus including non-volatile audio recording means mounted thereon. The apparatus also includes a first switch for activating the audio recording means to record audio data or replay recorded audio data; and a second manually operable switch which can choose the recording mode or replaying mode. The apparatus is contained in a pocket in the card.

The United States Patent Publication “Electronic greeting cards and novelties with moveable elements and manual electronic circuit activation (US 2010/0199530 A1)” disclosed an invention having electronic circuit and novelties. The electronic circuit has an operable switch mechanism through manual control on a movable part. The electronic circuit can be activated by manually controlling movable part. However, the operable switch mechanism may be unprotected.

A movable component is usually more visually effective, more attractively vivid, more interactive, and more expressive. However, a movable component is frequently damaged. It is difficult to use, store, transport, mail, and place a greeting card with a movable component. Thus, a greeting card that has both movable a component and an associated protective cover may be needed.

### BRIEF SUMMARY OF THE DISCLOSURE

One aspect of the present disclosure provides a greeting card having a back cover, a front cover, a control module, a movable component, and a protective cover. The back cover is configured as the base of the greeting card. The front cover is coupled to the back cover and contains a window. The front cover can be folded over the back cover. The control module is mounted within or on the back cover. The movable component is mounted within or on the back cover and is driven by the control module The window is located on a location on the front cover corresponding to the movable component. The protective cover is mounted within the window and configured to protect the movable component and provide moving space for the movable component.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary greeting card having a light module, a sound module and a motion module consistent with the disclosed embodiments;

FIG. 2 illustrates an exemplary greeting card having a light module, a sound module and a motion module consistent with the disclosed embodiment;

FIG. 3 illustrates an exemplary greeting card having a light module, a sound module and a motion module consistent with the disclosed embodiment in a side exploded view;

FIG. 4 illustrates an exemplary greeting card having rotating LED lights consistent with the disclosed embodiment;

FIG. 5 illustrates an exemplary greeting card having rotating LED lights consistent with the disclosed embodiment;

FIG. 6 illustrates an exemplary greeting card having rotating LED lights consistent with the disclosed embodiment in a side exploded view;

FIG. 6A illustrates an exemplary greeting card having rotating LED lights consistent with the disclosed embodiment in a partial side exploded view and a partial overhead exploded view;

FIG. 7 illustrates an exemplary advertisement card used in POS/POP consistent with the disclosed embodiment;

FIG. 8 illustrates an exemplary advertisement card used in POS/POP consistent with the disclosed embodiment;

FIG. 9 illustrates an exemplary advertisement card used in POS/POP consistent with the disclosed embodiment;

FIG. 10 illustrates an exemplary advertisement card used in a magazine consistent with the disclosed embodiment;

FIG. 11 illustrates a circuit diagram of a control module of an exemplary card consistent with the disclosed embodiment; and

FIG. 12 illustrates a circuit schematic of an exemplary greeting card consistent with the disclosed embodiment.

### DETAILED DESCRIPTION

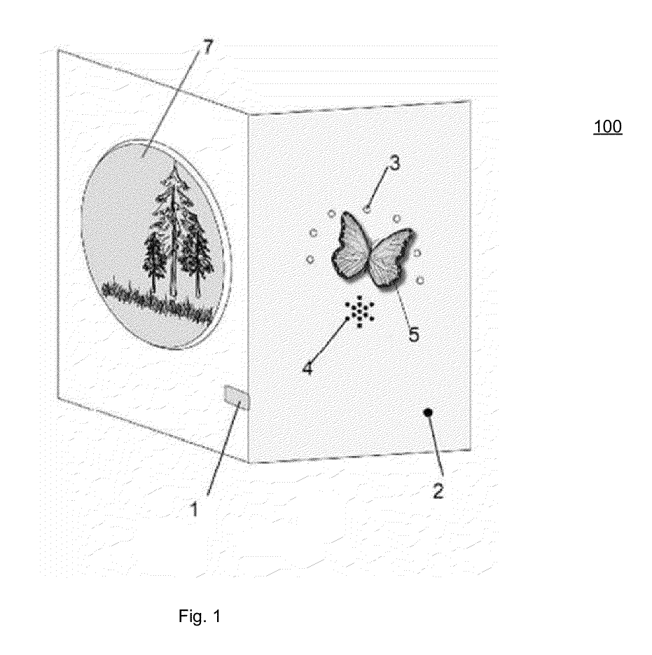

FIGS. 1-3 illustrate an exemplary greeting card 100, which may have simultaneous sound, light, and motion effects. As shown in FIGS. 1-3, the greeting card 100 includes a control switch 1, a second switch 2, a LED light 3, an amplifier 4, a movable component 5, a control module 6, a protective cover 7, a back cover 8, and a front cover 9. Certain components may be omitted and other components may be added.

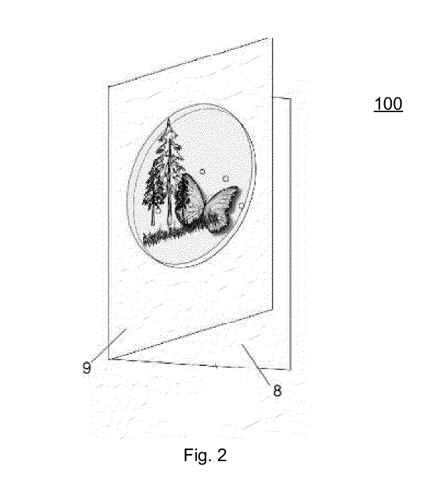

As shown in FIGS. 1 and 2, the exemplary greeting card 100 has a front cover 9 and a back cover 8. The back cover 8 is configured as the base of the greeting card. The front cover 9 is coupled to the back cover 8. The back cover 8 and front cover 9 can be folded together and the front cover 9 is folded over the back cover 8 when folded. Preferably, the front cover 9 and back cover 8 are made of paper.

The exemplary greeting card 100 includes a movable component 5, such as a butterfly. The movement of the movable component 5 is under the control of the control module 6. The movable component 5 of the exemplary greeting card 100 may be any movable objects such as small paper butterfly, small arms of the clock or watch, arms of a person, or small airplane. The movable component 5 may be mounted within or on the back cover 8.

The exemplary greeting card 100 may also optionally include an LED light 3 and an amplifier 4. The LED light 3 may flash under the control of the control module 6 and the amplifier 4 may output music under the control of the control module 6.

As shown in FIGS. 1 and 2, the front cover 9 may have a window. For example, a circular window may be positioned on the front cover 9. The window is located in a position that corresponds to the movable component 5. Depending on the design need of the movable component 5, the number of the windows may be one or more and the shape of the window may be circular, elliptic, square, rectangular, or even irregular.

As shown in FIGS. 1 and 2, a protective cover 7 is mounted within the window. The center part of the protective cover 7 is flat and protrudes from the peripheries of the protective cover 7 to a height. Therefore, the protective cover 7 would not contact any part of the movable component 5 and the movable component 5 is provided with space for movement. In the exemplary greeting card 100, the protective cover 7 may be mounted to the front cover 9 through gluing. The protective cover 7 may be mounted to the front cover 9 through any suitable method.

The protective cover 7 is usually made of any appropriate transparent or translucent material. For example, the protective cover 7 may be made of a blister material. More specifically, the protective cover 7 may be made of the Poly Ethylene Terephthalate (PET), the Poly Propylene (PP), the Poly Ethylene (PE) or the Polyvinyl Chloride (PVC). A purchaser can see the movable component 5 and other contents of the greeting card 100 through the transparent protective cover 7. These materials also usually have resilient nature and anti-impact strength for the protection of the movable component 5.

In the exemplary greeting card 100, the protective cover 7 is circular. The shape and the location of the protected cover 7 are decided by the size, shape and location of the movable component 5. The protective cover 7 is configured to protect the movable component 5 and to ensure that the movements of the movable component 5 are not interfered by the protective cover 7 or the window.

As shown in FIGS. 1 and 2, the transparent protective cover 7 is also a suitable substrate for printing or gluing image designs such as tree and grass thereon. Based on the needs of different occasions, words or other decorative designs may be printed or glued to the protective cover 7. Personalized messages may also be written on the protective cover 7 by a user.

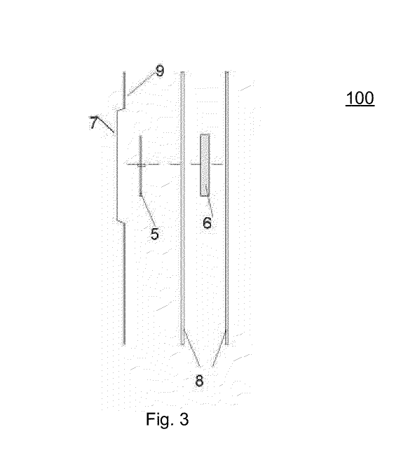

The exemplary greeting card 100 also includes a control module 6 as shown in FIG. 3. The control module 6 includes an integrated circuit, an electronic circuit, a battery, a control switch, and a driver. The control module 6 of the greeting card 100 may also optionally include an electronic module. The electronic module may be one or more of a sound module, a light module, and a video module to effectuate sound, light and/or video effect. In certain embodiments, the electronic module is an LED module, i.e., light-emitting diode module. In other embodiments, the electronic module is a rotating LED.

As shown in FIG. 3, for the purpose of safety and visual appeal, the control module 6 and its battery and switches may be mounted within the back cover 8. That is, the control module 6 and its battery and switches may be sealed inside the back cover 8. Further, the movable component 5, e.g., the butterfly, may be mounted on the back cover 8. Thus, a user would only see the movable component 5, but not the control module 6 no matter whether the greeting card is closed or open. The location and mounting method of the control module 6 and the movable component 5 may vary. For example, the control module 6 may also be mounted externally on the back cover 8.

The control module 6 of the exemplary greeting card 100 includes a control switch 1, such as a slide switch. One end of the slide switch is fixed to the front cover 9, as indicated by the slide switch 1 in FIG. 1, and the other end of the slide switch is movably attached to the back cover 8 (not shown in FIG. 1). Thus, when the card is opened or closed, the front cover 9 and the back cover 8 move against each other and the movable end of the slide switch 1 also moves.

The control module 6 of exemplary greeting card 100 may optionally include a second switch 2, such as a sensor switch. For example, the second switch 2 may detect when a user is blowing at the switch or the butterfly. Under this circumstance, the control switch 1 may be the master switch to control the activation of the control module 6. That is, when the control switch 1 is turned on, the control module 6 is in a standby state. The second switch 2 controls the activation of one or more of the motion, sound, and light effect. The second switch 2 may be chosen from different types of switches based on different needs and effects. For example, when a sensor switch responsive to blowing is used, an effect is created that the user's blow causes the movable component 5 to move when the second switch is turned on by the blowing. The second switch 2 can also be chosen from a variety of switches, such as a wafer switch, a rubber button switch, a membrane switch, a micro switch, a capacitive sensing switch, a sensor switch responsive to blowing, a sensor switch responsive to clapping, a cadmium sulfide photocell switch (CDS), a phototransistor switch, a human sensor switch, a motion sensor switch, an infrared sensor switch (IR), a tact switch, and/or a magnetic switch.

The control module 6 also includes a driver that drives the movable component. The driver may be a motor, a gear box or an electromagnet. Other types of driver may also be used.

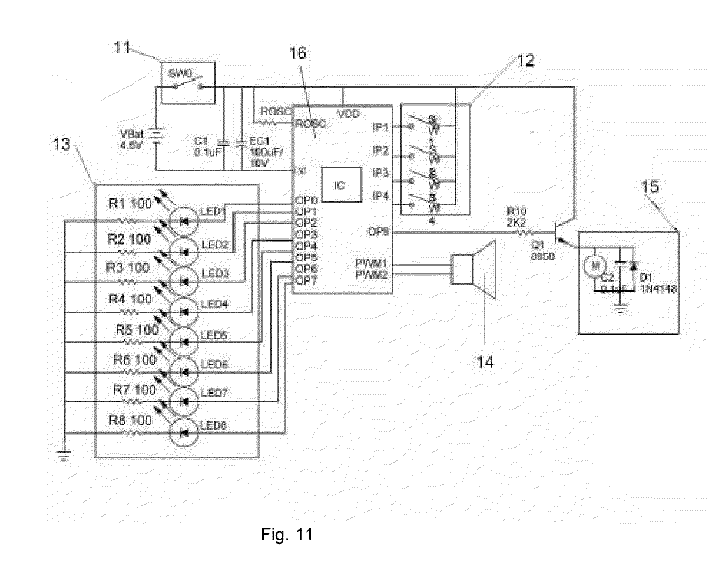

The circuit diagram of an exemplary control module 6 consistent with the disclosed embodiment is illustrated in FIG. 11. In FIG. 11, a unit 11 refers to a control switch unit. The control switch 1 in the control switch unit 11 may be a slide switch. A unit 12 refers to an optional second switch unit. The second switch 2 in the switch unit 12 can be chosen from a variety of switches, such as a wafer switch, a rubber button switch, a membrane switch, a micro switch, a capacitive sensing switch, a sensor switch responsive to blowing, a sensor switch responsive to clapping, a cadmium sulfide photocell switch (CDS), a phototransistor switch, a human sensor switch, a motion sensor switch, an infrared sensor switch (IR), a tact switch, and/or a magnetic switch. A unit 13 refers to an LED unit, with the function to create desired light effect. A unit 14 refers to an amplifier unit. The amplifier 4 in the amplifier unit 14 may output preset sound or music. A unit 15 refers to a motion unit. The motion unit 15 may include the movable component 5 and other devices such that the movable component can be driven by a driver such as a gear box, a motor or an electromagnet. A unit 16 refers to an integrated circuit. For example, the integrated circuit 16 may be a multiple control point unit (IC: MCU) that controls the entire control module 6. The slide switch 1 is turned on when the greeting card is opened, and the slide switch 1 can put the entire system in a standby state. Subsequently, the user can activate different elements such playing sound, moving the movable component, or emanating lights, through controlling the second switch 2.

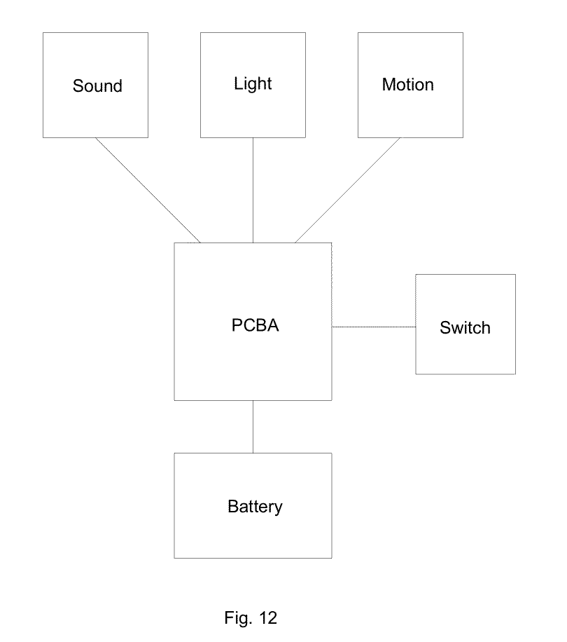

An circuit schematic of the exemplary card 100 is illustrated in FIG. 12. As shown in FIG. 12, a Printed Circuit Boards Assembly (PCBA) is simultaneously connected to a switch/trigger and a battery. Different modules may be mounted on the PCBA depending on the requirement to effectuate light, sound and/or motion effect.

Returning to the exemplary greeting card 100, the movements of the movable component 5 may be controlled by the control switch 1 alone. When the greeting card 100 is opened, the control switch 1 activates the entire control module 6 and the components that are controlled by the control module 6.

The movements of the movable component 5 may also be controlled by the control switch 1 together with other switching means. For example, with the optional second switch 2 included in the control module 6 of the greeting card 100, the slide switch 1 is activated simultaneously when the greeting card 100 is opened, so the slide is moved to the connecting position to connect the battery and PCBA, and the entire system is in a standby state. Then, a user can activate the second switch 2, a sensor switch responsive to blowing, by blowing at the second switch 2. The control module 6 can be pre-programmed to control multiple effects. In certain embodiments, the greeting card 100 includes an LED light 3 and an amplifier 4. Thus, the control switch 1 and the second switch 2 can selectively control the movement of the movable component 5, a butterfly, turn on the LED light 3 and play music or sound from the amplifier 4 according to the pre-setting. In the exemplary greeting card 100, the control module 6 on the PCBA effectuates the light, sound and motion effect simultaneously. However, the choices and combinations of the switch, light, sound and driver can be set differently according to the desired effect.

The protective cover 7 of the greeting card 100 can provide protection to the movable component 5, which achieves three dimensional and dynamic effect. Without the protective cover 7, the movable component 5 of the greeting card 100 may be damaged frequently. For example, without the protective cover 7, the wings and antenna of the butterfly may be broken easily when the front cover 9 is pressed. In the exemplary greeting card 100, the protective cover 7 protects the movable component 5 to facilitate transportation, storage, place and mail of the greeting card 100.

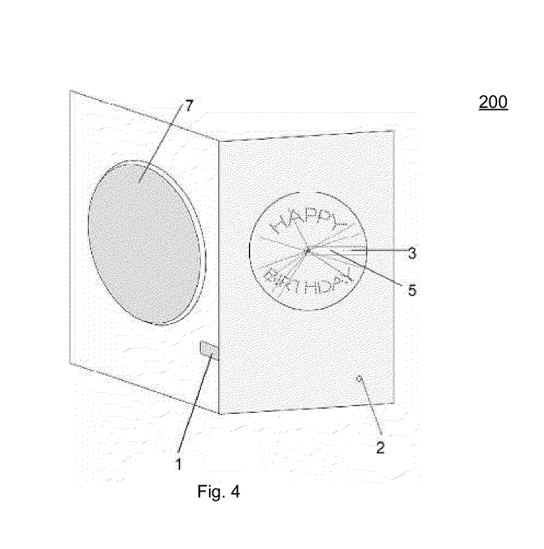

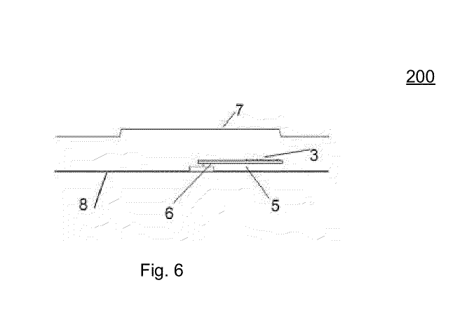

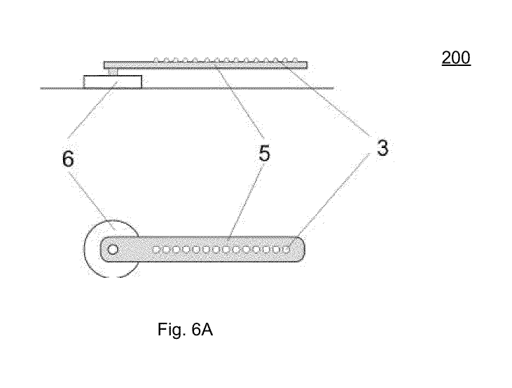

FIGS. 4-6A illustrate an exemplary birthday card 200 having a rotating LED module. As shown in FIGS. 4-6, the greeting card 200 includes a control switch 1, a second switch 2, a LED light 3, a movable component 5, a control module 6, a protective cover 7, a back cover 8, and a front cover 9. Certain components may be omitted and other components may be added.

The exemplary birthday card 200 has similar control switch 1, such as a slide switch, protective cover 7, back cover 8, and front cover 9 as those described in the exemplary greeting card 100. In the exemplary birthday card 200, the second switch 2 is a sensor switch responsive to clapping, the movable component 5 is a spinning light unit, and the control module 6 is a LED module.

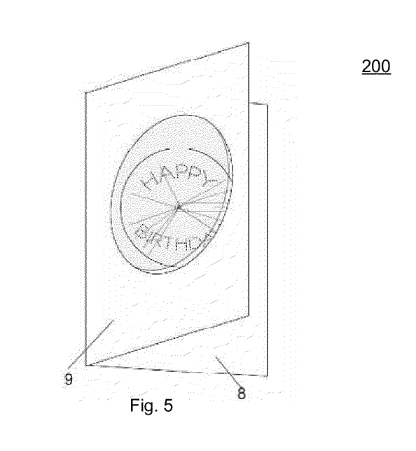

As shown in FIGS. 4 and 5, a circular window is opened on the front cover 9, with a protective cover 7 mounted within the window. The center part of the protective cover 7 is flat and protrudes from the peripheries of the protective cover 7 to a height. Therefore, the protective cover 7 would not contact any part of the movable component 5 and provide movement space for the movable component 5. The shape and the material of the protective cover 7 are similar to those described in exemplary greeting card 100.

As shown in FIGS. 4 and 5, a circular pattern in a corresponding position on the back cover 8 can be seen through the transparent circular protective cover 7. The movable component 5 is mounted inside the circular pattern and the movable component 5 may be a spinning light unit that connects to the center of the circle and extends from the center to the periphery. The LED light 3 may be mounted on the spinning light unit such that the spinning light unit may rotate the LED light 3 to effectuate a spinning light.

The PCBA of the control module 6 in the exemplary birthday card 200 integrates the light and motion elements. The control module 6 and the movable component 5 are both mounted on the back cover 8 in the exemplary birthday card 200.

When the exemplary birthday card 200 is opened, the slide switch 1 is turned on and the entire system is in a standby state. Subsequently, the user activates the control module 6 through the second switch 2, which is a sensor switch responsive to clapping, to turn on the LED light 3 and drive the movable component 5, the spinning light unit. The effect of spinning light is created by rotating the LED light 3 on the movable component 5.

When the slide switch 1 and the second switch 2 are turned on, the LED light 3 flashes regularly according to a preset pattern as configured in the LED module. Meanwhile, a wording “HAPPY BIRTHDAY” would appear around the center of the circular pattern according to a preset pattern as configured in the LED module. Meanwhile, the movable component 5, e.g., the spinning light unit, is driven by the control module 6 to rotate, generating flashing and spinning LED lights. A desired effect is created that flashing and spinning LED lights emanate from the center of the circle to the periphery.

The exemplary birthday card 200 may also integrate a sound module to play birthday music according to the presetting. In this case, the music “HAPPY BIRTHDAY” may be played under the control of the second switch 2, which simultaneously flashes the LED light 3, shows the wording “HAPPY BIRTHDAY,” and creates spinning LED. light.

In the exemplary birthday card 200, the protective cover 7 provides protection for the movable member 5. Further, on both the blank space of the birthday card and the protective cover 7, a sender can write personalized information that he wishes to convey according to his desire.

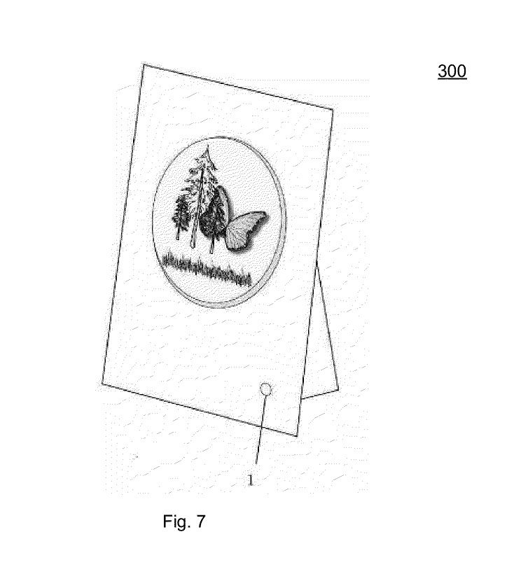

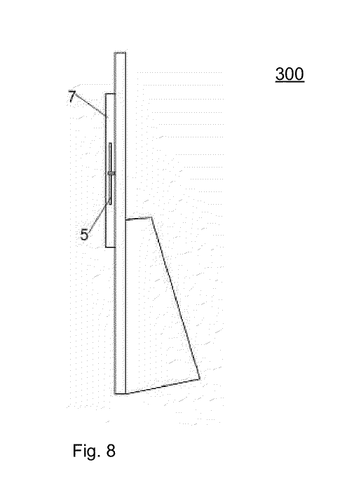

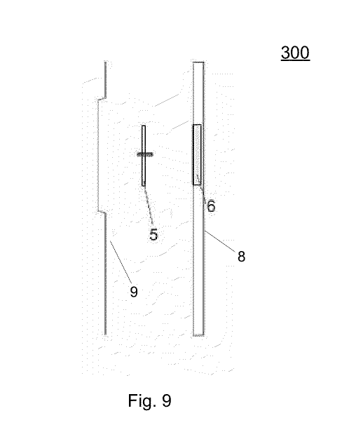

FIGS. 7-9 illustrate an exemplary advertisement card 300 that can be used at a point of purchase (POP) and/or a point of sale (POS). As shown in FIGS. 7-9, the advertisement card includes a control switch 1, a movable component 5, a control module 6, a protective cover 7, a back cover 8, and a front cover 9. Certain components may be omitted and other components may be added. The driver in the exemplary card 300 is a motor box, which is not shown because it is mounted within the back cover 8.

The control switch 1 in the exemplary advertisement card 300 is a human motion sensor switch. When a person approaches within a sensing distance, the movable component 5, e.g., a butterfly, is driven to move by the activated control switch 1. Other components, such as movable component 5, control module 6, and protective cover 7, are similar to those as described in the exemplary greeting card 100.

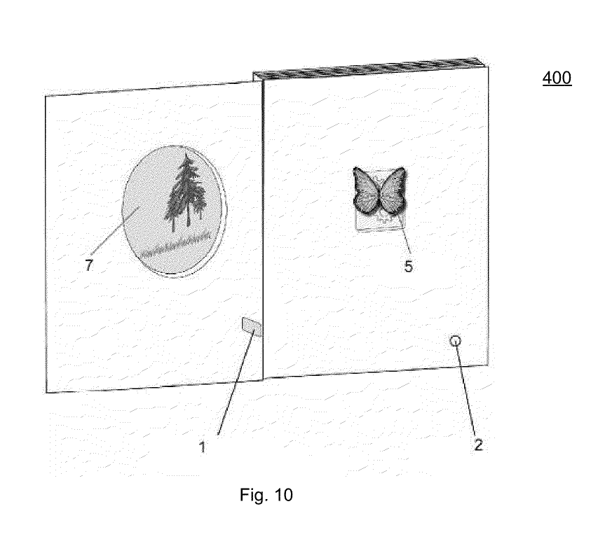

FIG. 10 illustrates another exemplary advertisement card 400. As shown in FIG. 10, the advertisement card 400 includes two consecutive pages in a book, a magazine or a periodical as a back cover and a front cover. As shown in FIG. 10, the exemplary advertisement card 400 includes a control switch 1, a second switch 2, a movable component 5, and protective cover 7. The second switch 2 is a tact switch in the exemplary advertisement card 400. Other components, such as the control switch 1, the movable component 5, and the protective cover 7, are similar to those as described in the exemplary greeting card 100.

The disclosed structures may be used in a variety of forms. As described above, the most common form of this disclosure is a greeting card (FIG. 1) or a promotional mailer. The disclosed structure may also be used as two consecutive pages of books, magazines or periodicals (FIG. 10), such as the cover pages of magazines or books (FIG. 10) or some pages of children's book to achieve three-dimensional, vivid, and realistic effects. Further, a greeting card with the disclosed structure may be designed as the surface of a gift box. Product information may be printed on the greeting card. The blank space on the greeting card may be left to allow a purchaser to write personalized information that the purchaser wishes to convey to a gift receiver. The gift box with the disclosed structure can achieve better display, sale or gift effect to attract consumers to purchase. The greeting card with the disclosed structure can also be used as advertisements at a point of purchase (POP)/a point of sale (POS), promotional packages such as limited release/commemorative edition gift liquor boxes. Such use can achieve better advertising effect or attract consumers.

While various embodiments and the accompanying figures have been shown and described, it is understood that they are not intended to limit the scope of the present invention.

What is claimed is:

1. A greeting card, comprising:
a back cover configured as the base of the greeting card;
a front cover coupled to the back cover and containing a window, wherein the front cover can be folded over the back cover;
a control module mounted within or on the back cover;
a movable component mounted within or on the back cover and being driven by the control module, wherein the window is located on a location on the front cover corresponding to the movable component; and
a protective cover mounted within the window and configured to protect the movable component and provide moving space for the movable component.

2. A greeting card according to claim 1, wherein the protective cover protrudes to a height according to a space requirement of the movable component.

3. A greeting card according to claim 1, wherein the protective cover is transparent or translucent.

4. A greeting card according to claim 1, wherein the control module further includes an electronic module, wherein the electronic module is one or more of a sound module, a light module, and a video module.

5. A greeting card according to claim 1, wherein the control module includes an integrated chip, an electronic circuit, an control switch and a driver, wherein the control switch activates the control module to move the movable component within a space.

6. A greeting card according to claim 5, wherein the control switch is a slide switch.

7. A greeting card according to claim 5, wherein the driver is one of a gear box, a motor, and an electromagnet.

8. A greeting card according to claim 5, wherein the control module further includes a second switch.

9. A greeting card according to claim 8, wherein the control switch is a master switch to control the activation the control module, and the second switch controls the activation of one or more of a motion effect, a sound effect, and a light effect.

10. A greeting card according to claim 8, wherein the second switch is chosen from one of a dome switch, a push button switch, a membrane switch, a micro switch, a capacitive sensing switch, a sensor switch responsive to blowing, a sensor switch responsive to clapping, a cadmium sulfide photocell switch, a phototransistor switch, a human sensor switch, a motion sensor switch, an infrared sensor switch, a tact switch, and a magnetic switch.

11. A greeting card according to claim 1, wherein the protective cover is made of a blister.

12. A greeting card according to claim 11, wherein the protective cover is made of one of PET, PP, PE and PVC.

13. A greeting card according to claim 1, wherein the window includes one or more windows.

14. A greeting card according to claim 1, wherein the window is in a shape of one of circle, ellipse, square, rectangle, and irregular shape.

15. A greeting card according to claim 1, wherein words and image designs are printed, written, or glued to the protective cover.

16. A greeting card according to claim 1, wherein the greeting card is used as a promotional mailer.

17. A greeting card according to claim 1, wherein the front cover and the back cover of the greeting card are used as two consecutive pages in a book, a magazine, or a periodical.

18. A greeting card according to claim 1, wherein the greeting card is used as a surface of a gift box.

19. A greeting card according to claim 1, wherein the greeting card is used as an advertisement card at a point of purchase/a point of sale.
